(19) United States
(12) Patent Application Publication
(10) Pub. No.: US 2024/0377069 A1
(43) Pub. Date: Nov. 14, 2024

(54) COOKING DEVICE AND OPERATING METHOD THEREOF

(71) Applicant: LG ELECTRONICS INC., Seoul (KR)

(72) Inventors: Eunkyung RYU, Seoul (KR); Hoseok DO, Seoul (KR)

(73) Assignee: LG ELECTRONICS INC., Seoul (KR)

(21) Appl. No.: 18/433,009

(22) Filed: Feb. 5, 2024

(30) Foreign Application Priority Data
May 11, 2023 (KR) 10-2023-0061251

(51) Int. Cl. F24C 7/08

(52) U.S. Cl. CPC F24C 7/085; F24C 7/086

(57) ABSTRACT

A cooking device can include a display; a cooking chamber; a heating part configured to heat the cooking chamber; and a camera configured to capture an image of food located inside the cooking chamber. Also, the cooking device further includes a processor configured to input the image into an image generation model that generates a changed image by manipulating a numerical value of an image attribute, generate a plurality of expected images representing cooking progress stages of the food based on an output of the image generation model, display the plurality of expected images on the display, receive a selection for a selected expected image among the plurality of expected images, and control the heating part to cook the food based on cooking information matched to the selected expected image.

### CROSS-REFERENCE TO RELATED APPLICATION

This application claims priority to Korea Patent Application No. 10-2023-0061251, filed in the Republic of Korea on May 11, 2023, the entirety of which is hereby expressly incorporated by reference into the present application.

### BACKGROUND

### Field

The present disclosure relates to a cooking device, and more particularly, to a cooking device for providing an expected cooking status of food.

### Discussion of the Related Art

A cooking device refers to a device or a home appliance for cooking by applying heat to a cooking object to be cooked. A cooking device using heat such as an oven is a useful home appliance in daily life.

In a situation where cooking is made using a cooking device, it is common for a person to continuously check a state or set a temperature and time to cook.

In addition, if food is cooked using a cooking device, an existing cooking image or an image on the Internet is provided as an image of an expected completion of cooking of the food.

However, in the related art, only a uniform image of completion of cooking was provided, and thus, the degree of cooking desired by the user was not specifically predicted or addressed.

Accordingly, there is a problem in that the cooking process of the food or the predicted result after cooking is not properly displayed, which does not meet the user's cooking needs.

### SUMMARY OF THE DISCLOSURE

An object of the present disclosure is to provide an expected image of food indicating a cooking state while maintaining the identity of the food.

An object of the present disclosure is to provide an expected image in which cooking degree characteristics are changed while maintaining the sameness of food.

According to an embodiment of the present disclosure, a cooking device includes a display unit, a cooking chamber, a heating unit configured to heat the cooking chamber, a camera configured to capture a food located inside the cooking chamber and a processor configured to generate a plurality of expected images representing a cooking progress stage of the food from the image of the food captured by the camera using an image generation model that generates a changed image by manipulating a numerical value of the image attribute, display the plurality of expected images of on the display and control the heating unit to cook the food using cooking information matched to the selected expected image according to a command for selecting one of the plurality of expected images.

According to an embodiment of the present disclosure, an operating method of the cooking device comprises capturing a food located inside the cooking chamber, generating a plurality of expected images indicating a cooking progress stage of the food from the captured image of the food by using an image generation model that generates a changed image by manipulating numerical values of attributes of the image, displaying a plurality of generated expected images and cooking the food using cooking information matching the expected image selected according to a command for selecting one of the plurality of expected images.

According to an embodiment of the present disclosure, there is an advantage that a customer can more accurately select a desired degree of cooking.

In addition, even if the type of food is the same, regardless of the shape or size of the food, it is possible to prevent a uniform expected image from being provided because expected images having a changed cooking degree characteristic are provided.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 is a block diagram illustrating a cooking device according to an exemplary embodiment of the present disclosure.

FIG. 2 is a perspective view of a cooking device according to an embodiment of the present disclosure.

FIG. 3 is a perspective view illustrating a state in which a door is opened in the cooking device of FIG. 2;

FIG. 4 is a flowchart illustrating a method of operating a cooking device according to an exemplary embodiment of the present disclosure.

FIG. 5A is a diagram illustrating the configuration of an image generation unit according to an embodiment of the present disclosure.

FIG. 5B is a process of generating a plurality of expected images corresponding to a plurality of cooking steps from a food image according to an embodiment of the present disclosure. It is a drawing explaining.

FIGS. 6A to 6F are diagrams illustrating examples of displaying a plurality of expected images and cooking information according to an embodiment of the present disclosure.

FIG. 7 is a diagram for explaining an example of providing sub-expected images that are more segmented according to selection of an expected image according to an embodiment of the present disclosure.

FIG. 8 is a diagram illustrating a cooking completion notification according to an embodiment of the present disclosure.

FIG. 9 is a diagram for explaining an example of displaying a cooking state for a current cooking step according to an embodiment of the present disclosure.

FIG. 10 is a diagram for explaining information provided if an expected cooking time corresponding to an expected image is changed according to an embodiment of the present disclosure.

FIGS. 11A and 11B are diagrams illustrating output information if a cooking failure situation occurs according to an embodiment of the present disclosure.

FIG. 12 is a ladder diagram for explaining an operating method of a cooking system according to an embodiment of the present disclosure.

### DETAILED DESCRIPTION OF THE EMBODIMENTS

Hereinafter, embodiments relating to the present disclosure will be described in detail with reference to the drawings. The suffixes “module” and “unit” for components used in the description below are assigned or mixed in consideration of easiness in writing the specification and do not have distinctive meanings or roles by themselves. Hereinafter, the embodiments disclosed in this specification will be described in detail with reference to the accompanying drawings, but the same or similar elements are given the same reference numerals regardless of reference numerals, and redundant description thereof will be omitted. The suffixes ‘module’ and ‘unit’ for the components used in the following description are given or used together in consideration of ease of writing the specification, and do not have meanings or roles that are distinct from each other by themselves. In addition, in describing the embodiments disclosed in this specification, if it is determined that a detailed description of a related known technology can obscure the gist of the embodiment disclosed in this specification, the detailed description thereof will be omitted. In addition, the accompanying drawings are only for easy understanding of the embodiments disclosed in this specification, the technical idea disclosed in this specification is not limited by the accompanying drawings, and all changes included in the spirit and technical scope of the present disclosure, it should be understood to include equivalents or substitutes.

Terms including ordinal numbers, such as first and second, can be used to describe various components, but the components are not limited by the terms. These terms are only used for the purpose of distinguishing one component from another.

It is understood that if a component is referred to as being ‘connected’ or ‘connected’ to another component, it can be directly connected or connected to the other component, but other components can exist in the middle. It should be. On the other hand, if a component is referred to as being ‘directly connected’ or ‘directly connected’ to another component, it should be understood that no other component exists in the middle.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, example embodiments of the present disclosure will be described in detail with reference to the accompanying drawings. All the components of each device or apparatus according to all embodiments of the present disclosure are operatively coupled and configured.

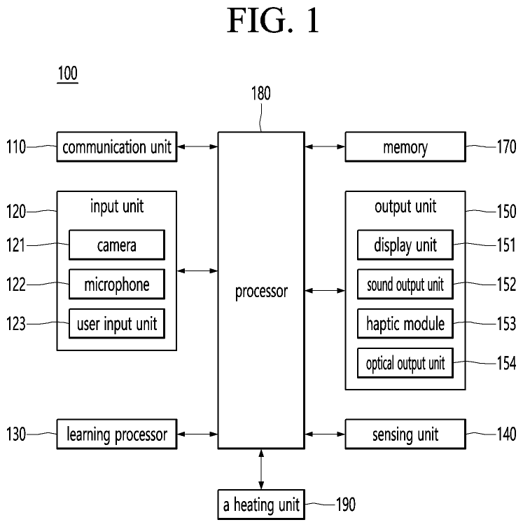

FIG. 1 is a block diagram illustrating a cooking device according to an exemplary embodiment of the present disclosure.

Referring to FIG. 1, the cooking device 100 can include a communication unit 110, an input unit 120, a learning processor 130, a sensing unit 140, an output unit 150, a memory 170, a processor 180, and a heating unit 190 can be included.

The communication unit 110 can transmit/receive data with external devices such as other AI devices or AI servers using wired/wireless communication technology. For example, the communication unit 110 can transmit/receive sensor information, a user input, a learning model, a control signal, and the like with external devices.

At this time, communication technologies used by the communication unit 110 include Global System for Mobile communication (GSM), Code Division Multi Access (CDMA), Long Term Evolution (LTE), 5G, Wireless LAN (WLAN), and Wi-Fi (Wireless-Fidelity), Bluetooth™, Radio Frequency Identification (RFID), Infrared Data Association (IrDA), ZigBee, and Near Field Communication (NFC).

The communication unit 110 can also be referred to as a communication modem or a communication circuit.

The input unit 120 can acquire various types of data.

At this time, the input unit 120 can include a camera for inputting a video signal, a microphone for receiving an audio signal, and a user input unit for receiving information from a user. Here, a camera or microphone can be treated as a sensor, and signals obtained from the camera or microphone can be referred to as sensing data or sensor information.

The input unit 120 can obtain learning data for model learning and input data to be used when obtaining an output using the learning model. The input unit 120 can obtain raw input data, and in this case, the processor 180 or the learning processor 130 can extract input feature as preprocessing of the input data.

The input unit 120 can include a camera 121 for inputting a video signal, a microphone 122 for receiving an audio signal, and a user input unit 123 for receiving information from a user.

Voice data or image data collected by the input unit 120 can be analyzed and processed as a user's control command.

The input unit 120 is for inputting image information (or signal), audio information (or signal), data, or information input from a user. For inputting image information, the cooking device 100 can include one or a plurality of cameras 121 can be provided.

The camera 121 processes an image frame such as a still image or a moving image obtained by an image sensor in a video call mode or a capturing mode. The processed image frame can be displayed on the display unit 151 or stored in the memory 170.

The microphone 122 processes external sound signal into electrical voice data. The processed voice data can be used in various ways according to the function (or application program being executed) being performed in the cooking device 100. Meanwhile, various noise cancellation algorithms can be applied to the microphone 122 to remove noise generated in the process of receiving an external sound signal.

The user input unit 123 is for receiving information from a user, if information is input through the user input unit 123, the processor 180 can control the operation of the cooking device 100 to correspond to the input information.

The user input unit 123 is a mechanical input means (or a mechanical key, for example, a button located on the front/rear or side of the cooking device 100, a dome switch, a jog wheel, a jog switch, etc.) and a touch input means. As an example, the touch input means consists of a virtual key, soft key, or visual key displayed on a touch screen through software processing, or a part other than the touch screen. It can be made of a touch key (touch key) disposed on.

The learning processor 130 can learn a model composed of an artificial neural network using training data. Here, the learned artificial neural network can be referred to as a learning model. The learning model can be used to infer a result value for new input data other than learning data, and the inferred value can be used as a basis for a decision to perform a certain operation.

At this time, the learning processor 130 can perform AI processing together with the learning processor of the AI server.

In this case, the learning processor 130 can include a memory integrated or implemented in the cooking device 100. Alternatively, the learning processor 130 can be implemented using the memory 170, an external memory directly coupled to the cooking device 100, or a memory maintained in an external device.

The sensing unit 140 can obtain at least one of internal information of the cooking device 100, surrounding environment information of the cooking device 100, and user information by using various sensors.

The sensors included in the sensing unit 140 include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a LiDAR sensor and radar, etc.

The output unit 150 can generate an output related to sight, hearing, or touch.

The output unit 150 can include a display unit that outputs visual information, a speaker that outputs auditory information, and a haptic module that outputs tactile information.

The output unit 150 can include at least one of a display unit 151, a sound output unit 152, a haptic module 153, and an optical output unit 154.

The display unit 151 displays (outputs) information processed by the cooking device 100. For example, the display unit 151 can display execution screen information of an application program driven by the cooking device 100 or UI (User Interface) and GUI (Graphic User Interface) information according to such execution screen information.

The display unit 151 can implement a touch screen by forming a mutual layer structure or integrally with the touch sensor. Such a touch screen can function as a user input unit 123 providing an input interface between the cooking device 100 and the user, and can provide an output interface between the terminal 100 and the user.

The audio output unit 152 can output audio data received from the communication unit 110 or stored in the memory 170 in reception of a call signal, communication mode or recording mode, voice recognition mode, or broadcast reception mode.

The sound output unit 152 can include at least one of a receiver, a speaker, and a buzzer.

The haptic module 153 generates various tactile effects that a user can feel. A representative example of the tactile effect generated by the haptic module 153 can be vibration.

The light output unit 154 outputs a signal for notifying occurrence of an event using light from a light source of the cooking device 100. Examples of event occurring in the cooking device 100 can include message reception, call signal reception, missed calls, alarms, schedule notifications, e-mail reception, and information reception through applications.

The memory 170 can store data supporting various functions of the cooking device 100. For example, the memory 170 can store input data obtained from the input unit 120, learning data, a learning model, a learning history, and the like.

The processor 180 can determine at least one executable operation of the cooking device 100 based on information determined or generated using a data analysis algorithm or a machine learning algorithm. Also, the processor 180 can perform the determined operation by controlling components of the cooking device 100.

To this end, the processor 180 can request, retrieve, receive, or utilize data from the learning processor 130 or the memory 170, control components of the cooking device 100 for performing a predicted operation or an operation determined to be desirable among the at least one executable operation.

In this case, the processor 180 can generate a control signal for controlling the external device and transmit the generated control signal to the external device if it is necessary to link the external device to perform the determined operation.

The processor 180 can obtain intention information for a user input and determine a user's requirement based on the acquired intention information.

At this time, the processor 180 uses at least one of a STT (Speech To Text) engine for converting a voice input into a character string and a Natural Language Processing (NLP) engine for obtaining intention information of a natural language, and Intent information corresponding to the input can be obtained.

At this time, at least one or more of the STT engine or NLP engine can be composed of an artificial neural network at least partially trained according to a machine learning algorithm. And, at least one or more of the STT engine or the NLP engine can be learned by the learning processor 130, learned by the learning processor of the AI server, or learned by distributed processing thereof.

The processor 180 collects and stores history information including user feedback on the contents of operation or operation of the cooking device 100 and stores it in the memory 170 or the learning processor 130, or in an external device such as an AI server. can transmit The collected history information can be used to update the learning model.

The processor 180 can control at least some of the components of the cooking device 100 to drive an application program stored in the memory 170. Furthermore, the processor 180 can combine and operate two or more of the components included in the cooking device 100 to drive the application program.

The heating unit 190 can generate heat using supplied energy.

The heating unit 190 can generate heat using supplied electricity and heat the inside of the cooking device 100 using the generated heat.

The heating unit 190 can be provided inside the cooking chamber 12. The heating unit 190 can be disposed at a side end or a lower end of the cooking chamber 12.

The heating unit 190 can include a circuit that converts electrical energy into thermal energy.

Hereinafter, the cooking device 100 can also be referred to as an artificial intelligence cooking device 100 or an artificial intelligence oven.

Also, if the cooking device 100 is provided in a form attached to a wall, it can be referred to as a wall oven.

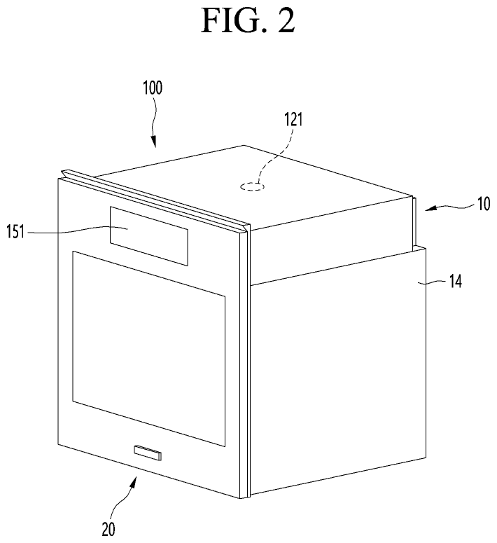

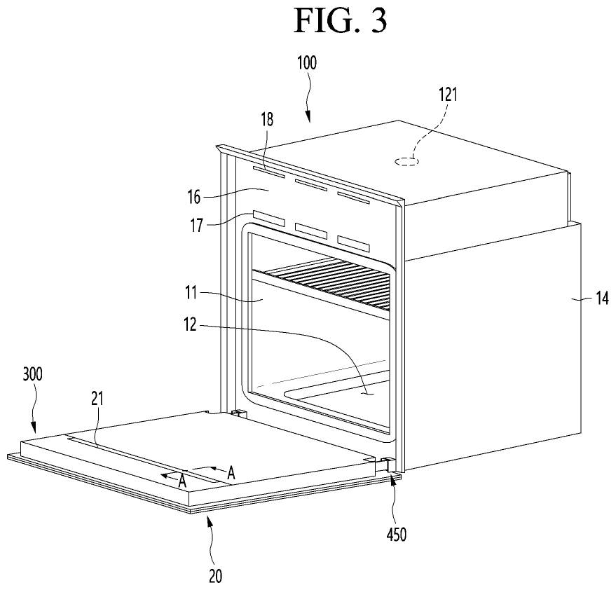

FIG. 2 is a perspective view of a cooking device according to an embodiment of the present disclosure, and FIG. 3 is a perspective view showing a door of the cooking device of FIG. 2 in an open state.

The cooking device 100 can include a main body 10 accommodating various components therein.

The main body 10 can include an inner frame 11 forming a cooking chamber 12 and an outer frame 14 surrounding the inner frame 11 outside the inner frame 11.

A camera 121 can be provided at an upper end of the inner frame 11. The camera 121 can capture the cooking chamber 12. The captured image can be used to recognize ingredients being cooked.

A body panel 16 can be provided at the front end of the inner frame 11.

The body panel 16 can be coupled to the front end of the inner frame 11 or integrally formed with the front end.

The door 20 can be rotatably connected to the main body 10 by a hinge mechanism 450.

For example, the hinge mechanism 450 can be connected to the lower end of the door 20.

In order to minimize a rise in temperature due to heat supplied to the cooking chamber 12, air outside the door 20 can flow into the door 20.

Therefore, the door 20 includes a door air outlet 21 through which the air flows out from inside the door (20), and the body 10 can include a body air inlet 17 flowed in the air flowed out through the door air outlet 21.

The body air inlet 17 can be formed in the body panel 16.

In addition, the air flowed into the body 10 through the body air inlet 17 can be flowed out the outside of the body 10 through the body air outlet 18 after flowing through the body 10.

A body air outlet 18 can also be formed in the body panel 16.

The door 20 can further include a control device 300.

The control device 300 is located on the upper side of the door 20, but is not limited thereto, and can be positioned to face the portion of the body panel 16 located on the upper side of the cooking chamber 12 in a state that the door 20 is closed.

The control device 300 can include one or more of a display unit 151 and a user input unit 123.

The display unit 151 can be implemented in the form of a touch screen capable of receiving a touch input.

Operation information of the cooking device 100 can be displayed and/or a user's operation command can be received through the control device 300.

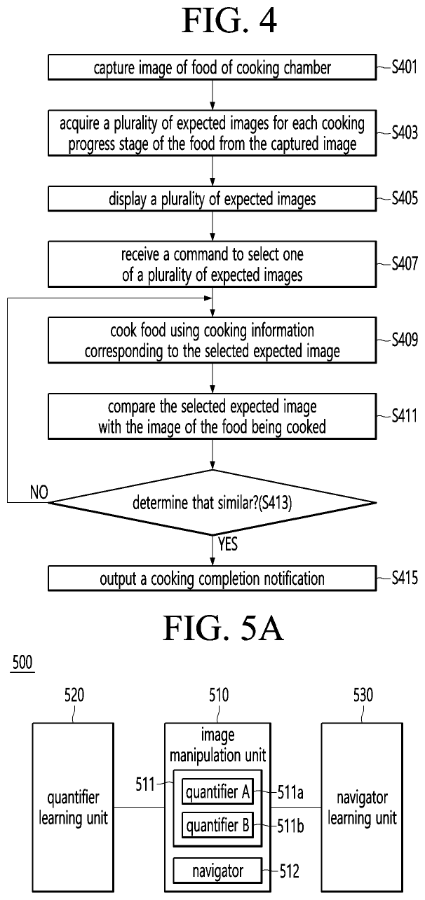

FIG. 4 is a flowchart illustrating a method of operating a cooking device according to an exemplary embodiment of the present disclosure.

Referring to FIG. 4, the processor 180 of the cooking device 100 can capture an image of food through the camera 121 (S401).

In one embodiment, if food is stored in the cooking compartment 12, the processor 180 can turn on the camera 121 to capture the interior of the cooking compartment 12.

In another embodiment, the processor 180 can turn on the operation of the camera 121 if receiving a cooking start command.

The processor 180 can acquire a plurality of expected images for each cooking progress stage of the food from the captured image using the image generation unit (S403).

The image generation unit can be an image generation model that quantifies the attribute of the image and generates a plurality of expected images by manipulating the image according to manipulation of the corresponding numerical value.

The image generation unit can be a model for identifying the type of food from the image and generating expected images for each cooking step corresponding to the type of the identified food.

Each of the plurality of cooking steps can indicate a step according to a progress level of cooking.

In one embodiment, a plurality of cooking steps can be separated by a certain period of time.

In another embodiment, the plurality of cooking steps can be classified according to the degree of cooking of the food.

In another embodiment, each of the plurality of cooking steps can be a step within an ingestible range of food.

Corresponding cooking information can be matched with the expected image. The cooking information can include one or more of cooking temperature, cooking time, and degree of cooking.

The image generation model (image generation unit) can be learned by the artificial intelligence server, received from the artificial intelligence server, and stored in the memory 170 of the cooking device 100.

As another example, the processor 180 can transmit the captured image to the artificial intelligence server through the communication unit 110. The artificial intelligence server can generate a plurality of expected images from the image using an image generation unit, and transmit the generated plurality of expected images to the cooking device 100 or the user's mobile terminal.

The mobile terminal can be a terminal such as a user's smart phone, smart pad, or PC.

After identifying food from the input food image, the image generation unit can generate a plurality of expected images corresponding to the identified food.

As another embodiment, a separate object identification model for identifying the image generation unit and the type of food can be provided.

The object identification model can identify the type of food from the food image through a Faster R-CNN (Regions with Convolution Neural Networks) method.

The Faster R-CNN (Regions with Convolution Neural Networks) method will be described in detail.

First, a feature map is extracted from an image through a Convolution Neural Network (CNN) model. Based on the extracted feature map, a plurality of regions of interest (RoI) are extracted. Then, RoI pooling is performed for each region of interest.

RoI pooling sets the grid so that the feature map on which the region of interest is projected fits in a predetermined H×W size, extracts the largest value for each cell included in each grid, and produces a feature map with H×W size. It is a process of extraction.

A feature vector is extracted from the feature map having a size of H×W, and identification information representing the type of food can be obtained from the feature vector.

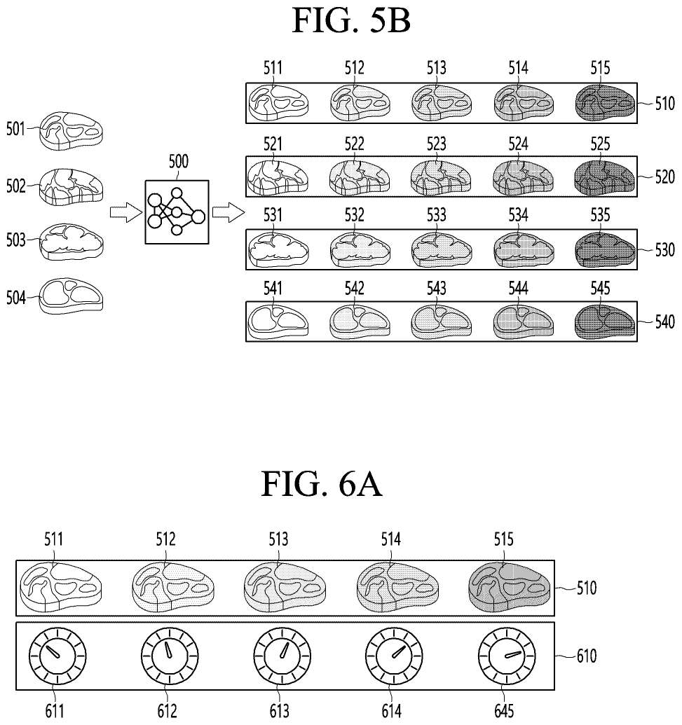

FIG. 5A is a diagram illustrating the configuration of an image generation unit according to an embodiment of the present disclosure, and FIG. 5B is a process of generating a plurality of expected images corresponding to a plurality of cooking steps from a food image according to an embodiment of the present disclosure.

The image generating unit 500 can be a component included in any one of the learning processor 130, the memory 170, or the processor 180, or can be a separate component.

The image generating unit 500 can also be referred to as an image generating model.

Referring to FIG. 5A, the image generation unit 500 can include an image manipulation unit 510, a quantifier learning unit 520, and a navigator learning unit 530.

The image manipulation unit 510 can include a quantifier 511 and a navigator 512.

The quantifier 511 can be referred to as an attribute quantifier, and can determine (or estimate) the degree of an attribute (or amount of an attribute) to be edited.

Here, the properties can include various properties that can be transformed or manipulated in the image, and for example, in the case of food, it can include the degree of cooking, size, shape, and the like.

For each attribute of the image, the degree (strength) of the attribute can be defined as a standardized value.

Specifically, if an attribute to be adjusted and a target value are input for an arbitrary input image (or a received image), the image generation unit 500 can generate an image in which the corresponding attribute is changed by the target value.

The image generating unit 500 can automatically generate an expected image in which an attribute is changed by a target value without a process in which a user determines the degree of an attribute by looking at an input image or a generated image.

To this end, the image generating unit 500 of the present invention the quantifier 511 for measuring the degree of attributes of an image and a navigator 512 (or navigator) that performs manipulation by exploring latent space the potential of an image generating AI model (Image Generative model) based on the quantifier 511.

The image generating AI model (Generative Adversarial Network) can include a Generative Adversarial Networks (GAN), a Vector AutoEncoder (VAE) model, a diffusion model, and the like.

The image generating unit 500 of the present invention is characterized by performing a search within a latent space of an image generating AI model. However, in the following, for convenience, the operation method will be described mainly based on the GAN (Generative Adversarial Network) model.

The navigator 512 can perform a search within the latent space of the generative adversarial networks (GAN) model to transform the attribute of the image by the degree determined by the quantifier 511.

The quantifier 110 can provide standardized value for attribute of the image to be manipulated.

Specifically, the standardized value can be set to a value between 0 and 1.

To this end, the image generating unit 500 of the present invention can further include a quantifier learning unit 520 that trains the quantifier 511 so that the quantifier 511 quantifies the conversion degree of the attribute.

The quantifier learning unit 520 can train the quantifier 511 to define standardized value for attribute manipulation with a small number of images.

The quantizer learning unit 520 can train the quantifier 511 using a custom attribute dataset in order to perform learning on a specific attribute (for example, degree of cooked food).

The quantifier learning unit 520 can define (or learn) a standardized numerical value for a specific attribute (for example, level of learning) corresponding to the custom attribute dataset by using the custom attribute dataset.

Thereafter, the image generation unit 510 can receive a target input value for the corresponding attribute as a standardized numerical value, it is possible to create an image with manipulated property as much as a desired degree (amount, size, or numerical value) by receiving an input random image (or received image) as an input.

For example, the user selects the attributes (degree of cooking, shape, etc.) of the food to be manipulated, and then, depending on the degree of the attribute (or strength of the attribute), a plurality of steps (for example, 4 to 1) between 0 and 1 10 steps), and learning can be performed using one or more custom attribute datasets (for example, 1 to 5 reference images) for each step.

For example, if learning the quantifier for the attribute of the degree of cooking, the quantifier learning unit 520 divides the range from 0 to 1 into about 10 steps, and designates a custom attribute dataset in order of the degree of cooking to quantify the operation range and steps for attribute of the degree of cooking of the food.

At this time, the step can be set to a standardized value between 0 and 1.

The quantifier 511 can be learned to output normalized value from image.

The navigator 512 can perform a search within the latent space of a generative adversarial network (GAN) model to transform the attribute of the image by the degree determined by the quantifier 511 (e.g., the amount of attributes to transform).

For example, the GAN model included in the image generation unit 500 of the present invention can be formed to generate (or manipulate) a food image.

The navigator 512 can perform image manipulation by moving the quantity vector by the degree to which the attribute determined by the quantifier 511 is transformed within the latent space of the GAN model.

At this time, the navigator 512 can be trained so that the quantity vector does not deviate from the latent space.

The image generation unit 500 moves the quantity vector in the latent space, and can further include a navigator learning unit 530 that performs the learning of the navigator 512 through the value change of the quantifier 511 for the manipulated image if the image is manipulated by the movement of the quantity vector.

The navigator learning unit 530 can learn the navigator 512 so that the target quantity vector input through the quantifier 511 and the estimated quantity vector obtained by inversely estimating the numerical change of the quantifier 511 through image manipulation through the latent space are matched with each other.

The phenomenon appears in the order of movement in the latent space, change occurrence in the received image, and change occurrence in the value of the quantifier 511 for the changed image.

The navigator learning unit 530 can learn the navigator 512 using this correlation.

After learning, if the target value for the image to be created (manipulated) is reversely inputted through the quantifier 511, the navigator 512 moves the quantity vector in the latent space that causes the manipulation.

By applying the movement of the quantity vector to the image, the image generating unit 500 of the present invention can generate a manipulated image having a desired target value.

The image manipulation unit 510 can include a plurality of quantifiers 110a and 110b to correspond to a plurality of attributes to manipulate a plurality of attributes.

Each of the plurality of quantifiers can be configured to manipulate a different attribute, and each quantifier can be configured to provide a standardized value for that attribute.

If conversion requests for different attributes are received through a plurality of quantifiers, the navigator 512 of the present invention can manipulate an image so that the received plurality of attributes are reflected together.

For example, a conversion request for a first attribute (for example, degree of learning) can be received through the first quantifier 110a, and a conversion request for a second attribute (for example, shape or color) can be received through the second quantifier 110b.

In this case, the navigator 512 can convert attribute of the received image the conversion to correspond the conversion degree of the received first attribute through the standardized value provided by the first quantifier 110a and the conversion degree of the received second attribute through the standardized value provided by the second quantifier 110b.

Thereafter, the navigator 512 can generate and output a manipulated image in which the first attribute and the second attribute are both reflected.

Referring to FIG. 5B, an image generation unit 500 based on an artificial neural network is shown.

It is assumed that the types of food represented by the first to fourth food images 501 to 504 are the same. The type of food can be meat.

If the first food image 501 is input, the image generation unit 500 can generate a first expected image set 510 representing a plurality of cooking stages of the food of the first food image 501.

The first set of expected images 510 can include a plurality of expected images 511 to 515 indicating the degree of cooking progress of the food corresponding to the first food image 501.

Each of the plurality of expected images 511 to 515 can be an image indicating how much cooking has progressed according to the lapse of cooking time.

Each expected image can be an image distinguishable from other expected images according to cooking characteristics such as degree of cooking, cooking temperature, cooking time, and shape.

If the second food image 502 is input, the image generation unit 500 can generate a second expected image set 520 representing a plurality of cooking stages of the food of the second food image 502.

The second expected image set 520 can include a plurality of expected images 521 to 525 representing the degree of cooking progress of food corresponding to the second food image 502.

Each of the plurality of expected images 521 to 525 can be an image indicating how much cooking has progressed according to the lapse of cooking time.

If the third food image 503 is input, the image generation unit 500 can generate a third expected image set 530 representing a plurality of cooking stages of the food of the third food image 503.

The third expected image set 530 can include a plurality of expected images 531 to 535 representing the degree of cooking progress of the food corresponding to the third food image 503.

Each of the plurality of expected images 531 to 535 can be an image indicating how much cooking has progressed according to the lapse of cooking time.

If the fourth food image 504 is input, the image generation unit 500 can generate a fourth expected image set 540 representing a plurality of cooking stages of the food of the fourth food image 504.

The fourth expected image set 540 can include a plurality of expected images 541 to 545 representing the degree of cooking progress of the food corresponding to the fourth food image 504.

Each of the plurality of expected images 541 to 545 can be an image indicating how much cooking has progressed according to the lapse of cooking time.

The number of expected images included in each expected image set is 5 as an example, but this is only an example.

The image generation unit 500 can generate different types of expected images according to the image of the food, even if it is the same type of food.

The cooking progress step can be distinguished by one or more of the cooking time period, the degree of cooking of the food, and the degree of change in the shape of the food.

In one embodiment, a plurality of cooking steps corresponding to each of a plurality of expected images can be classified according to a predetermined time period.

In another embodiment, a plurality of cooking steps corresponding to each of the plurality of expected images can be classified according to the degree of change of the food. The degree of change of food can be one or more of a degree of cooking or a degree of change in shape.

For example, a first expected image and a second expected image that is a next cooking step of the first expected image can have different degree of cooking.

Again, FIG. 4 will be described.

The processor 180 can display a plurality of expected images on the display unit 151 (S405).

The processor 180 can display one or more of a plurality of expected images on the display unit 151.

The processor 180 can display cooking information matching the expected image adjacent to each of the plurality of expected image.

The cooking information can include information about an expected image. The cooking information can be information about a cooking state.

The cooking information can include one or more of a degree of cooking, an expected cooking temperature, and an expected cooking time.

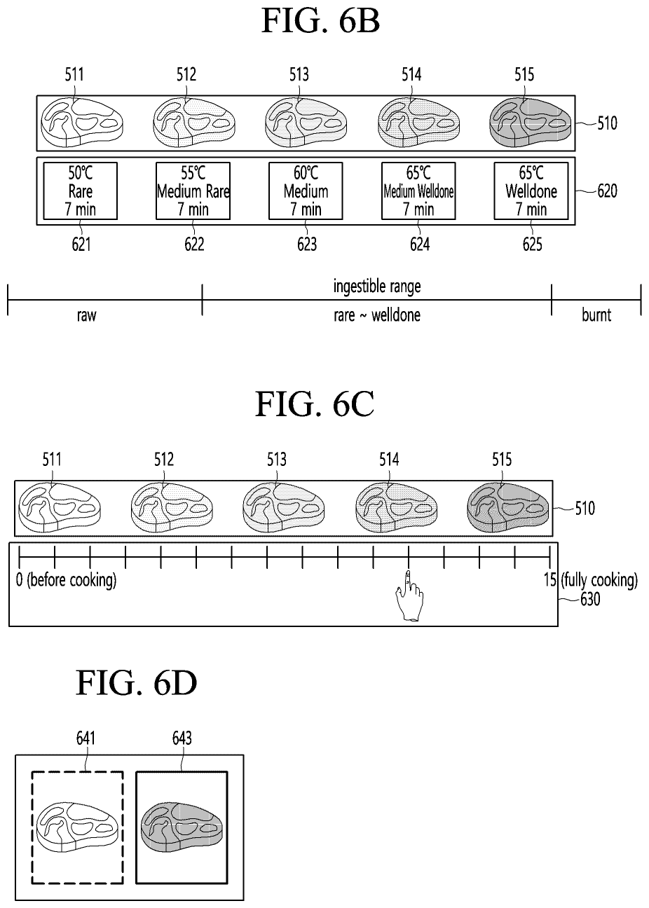

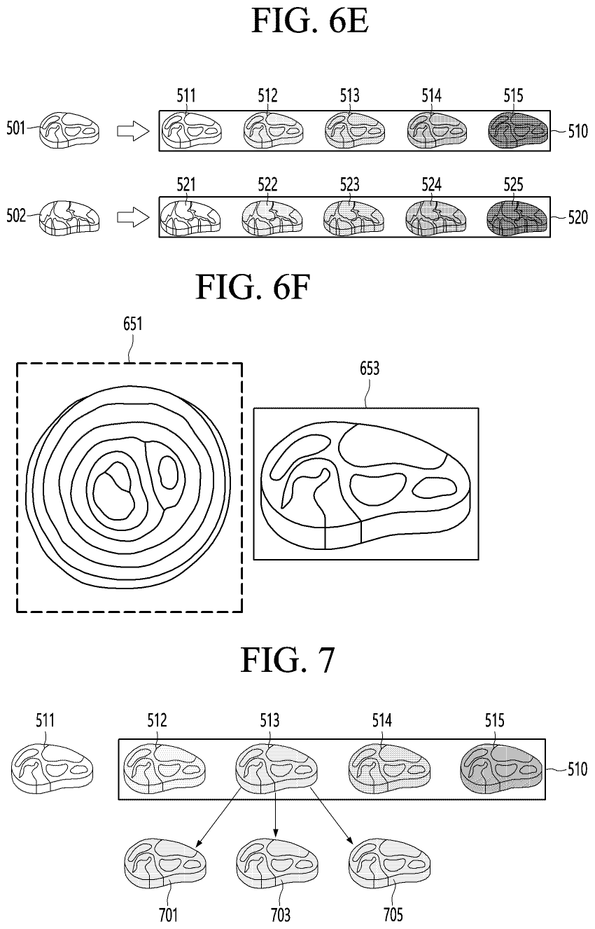

FIGS. 6A to 6F are diagrams illustrating examples of displaying a plurality of expected images and cooking information according to an embodiment of the present disclosure.

Referring to FIG. 6A, a first expected image set 510 generated by an image generation model 500 is shown.

The display unit 151 provided in the cooking device 100 can display a first expected image set 510 including a plurality of expected images 511 to 515 generated through the image generation model 500.

The user can select an expected image reflecting a desired cooking state through the first expected image set 510. Accordingly, food can be cooked in a state in which the user's needs are more accurately reflected.

The processor 180 can further display a guide image set 610 including a plurality of manipulation images 611 to 615 in addition to the first expected image set 510.

Each of the plurality of manipulation images 611 to 615 can correspond to each of the plurality of expected images 511 to 515. Each of the plurality of manipulation images 611 to 615 can be an image guiding a manipulation button to be manipulated to cook food in a cooking state corresponding to each expected image.

Each manipulation image can guide one or more of cooking time or cooking temperature.

The user can be assisted in selecting an expected image reflecting a desired cooking state through the guide image set 610.

In another embodiment, each of the plurality of expected images 511 to 515 can be displayed in association with a physical manipulation button. That is, the display unit 151 displays an expected image and the processor 180 can automatically control the manipulation button so that the food is cooked according to the cooking information matching the displayed expected image.

Referring to FIG. 6B, the processor 180 can further display the cooking information set 620 on the display unit 151 together with the first expected image set 510.

The cooking information set 620 can include a plurality of cooking information items 621 to 625.

Each cooking information item can include information about the cooking state of each expected image.

Each cooking information item can include one or more of an expected cooking temperature, an expected cooking degree, and an expected cooking time.

The user can be assisted in selecting an expected image reflecting a desired cooking state through the cooking information set 620.

According to another embodiment of the present disclosure, the processor 180 can display the first expected image set 510, the guide image set 610, and the cooking information set 620 on the display unit 151.

On the other hand, the expected images 511 to 515 displayed on the display unit 151 can be cases in which the degree of cooking is within an ingestible range. That is, only the expected images 511 to 515 within the ingestible range can be displayed on the display 151.

Referring to FIG. 6C, the processor 180 can further display a cooking degree bar 630 on the display unit 151 together with the first expected image set 510.

The cooking degree bar 630 can be a numerical value indicating the degree of cooking of food corresponding to each of a plurality of cooking steps.

The cooking degree bar 630 can be divided into a plurality of levels, and the plurality of levels can indicate a degree of cooking.

The user can select a desired degree of cooking through the cooking level bar 630.

As such, according to an embodiment of the present disclosure, the user can more specifically select a desired degree of cooking through the cooking degree bar 630.

Referring to FIG. 6D, the processor 180 can display recommended expected images 641 and 643 corresponding to the recommended cooking steps on the display unit 151.

In an embodiment, the processor 180 can obtain a recommended cooking step for a specific food based on a previously stored user's past cooking history.

If the food is steak, the first recommendation expected image 641 can correspond to a medium stage of six cooking stage among a total of 10 cooking stages, and the second recommendation expected image 643 can correspond to a well-done stage of 8 cooking stage.

The processor 180 can display the recommended expected images 641 and 643 together with the first expected image set 510. Each of the recommended expected images 641 and 643 can be any one of the expected images included in the first expected image set 510.

Through the recommendation expected images 641 and 643, a guide for cooking prediction of food can be provided to the user in more detail.

As another embodiment, recommendation expected images can be displayed separately within the expected image set 510 without separate display of the recommended expected images.

FIG. 6E assumes that two foods are stored in the cooking chamber 12 and cooked.

The processor 180 can generate a first expected image set 510 based on the first food image 501 according to being captured the first food, and generate a second expected image set 520 based on the second food image 501 according to being captured the second food.

The first food and the second food can be of the same type or of different types.

The processor 180 can simultaneously display the first expected image set 510 and the second expected image set 520 on the display 151.

That is, even if a plurality of foods are cooked, the processor 180 can identify each food and display expected images corresponding to the identified food.

FIG. 6F is a diagram illustrating that recommendation expected images are provided if two different types of food are stored in the cooking chamber 12.

The third recommendation expected image 651 can be a five-stage image of an onion generated through the image generation model 500.

The fourth recommendation expected image 653 can be an image of a six stage (medium) of steak generated through the image generation model 500.

The third and fourth recommended expected images 653 and 655 can be displayed together with an onion image set and a steak image set.

As described above, according to an embodiment of the present disclosure, even if a plurality of foods are cooked, a set of expected images and a recommended expected image for each food can be provided so that the user's cooking options for the food can be expanded.

As another embodiment, the recommended expected image can be displayed separately from each of a plurality of expected image sets without separate display of the recommended expected image.

Meanwhile, if any one of the images included in the first expected image set 510 is selected, a cooking step corresponding to the selected image can be subdivided and displayed.

FIG. 7 is a diagram for explaining an example of providing sub-expected images that are more segmented according to selection of the expected image according to an embodiment of the present disclosure.

If the third expected image 513 included in the first expected image set 510 is selected, the processor 180 can display a plurality of sub expected images 701, 703, and 705 in which the cooking step of the selected image is further subdivided on the display unit 151.

In another embodiment, the processor 180 can display only cooking steps (for example, steps 5 to 8) within a certain range among 10 steps on the display unit 151 according to a user command.

The user command can be either a touch input or a voice command.

Again, FIG. 4 will be described.

The processor 180 receives a command to select one of a plurality of expected images (S407), and cooks food using cooking information corresponding to the selected expected image according to the received command (S409).

The processor 180 can store cooking information corresponding to each expected image in the memory 170 by matching the corresponding expected image.

The processor 180 can extract cooking information corresponding to the selected expected image from the memory 170 according to a command for selecting the expected image.

The processor 180 can cook the food in the cooking chamber 12 according to the extracted cooking information. After selecting the expected image, the processor 180 can automatically cook food to be similar to the result of the selected expected image while changing at least one of the cooking time and cooking temperature.

In one embodiment, the processor 180 can initially cook the food at a low temperature, then cook the food at a high temperature over time. At the same time, the processor 180 can reduce the cooking time of food.

In another embodiment, the processor 180 can initially cook the food at a high temperature, then cook the food at a low temperature over time. At the same time, the processor 180 can increase the cooking time of the food.

The processor 180 can compare the selected expected image with the image of the food being cooked (S411).

The processor 180 can capture the food being cooked after starting cooking of the food.

The processor 180 can measure a similarity between the image of food being cooked and the selected expected image.

The processor 180 can measure similarity between two images through a pixel-wise operation in image space. A pixel-wise operation can be an operation in which the same operation is applied to each of a plurality of pixels constituting an image.

The processor 180 can obtain a mean squared error (MSE), which is a square difference between pixel values of the two images, as a similarity between the two images.

The processor 180 can obtain the measured MSE as a similarity between the two images using the following [Equation 1].

$$MSE = \frac{1}{n} {\sum }_{i = 1}^{n} {( {Y}_{i} - {\hat{Y}}_{i} )}^{2} \qquad [ Equation 1 ]$$

where n is the total number of pixels, Yᵢ is the i-th pixel value of the expected image, Ŷᵢ can be the i-th pixel value of the image being cooked.

In another embodiment, the processor 180 can obtain a Frechet inception distance (FID) as a similarity between two images. The FID can be an index indicating how similar the distribution of the expected image and the distribution of the image being cooked are.

The processor 180 can obtain the calculated FID as a similarity between the two images using the following [Equation 2].

$$FID = {d}^{2} = {‖ {μ}_{1} - {μ}_{2} ‖}_{2}^{2} - Tr ( {\sum }_{1} + {\sum }_{2} - 2 {\sum }_{1} {\sum }_{2} ) \qquad [ Equation 2 ]$$

Since the method of measuring FID is an available technique, a detailed description thereof will be omitted.

In another embodiment, the processor 180 can acquire Learned Perceptual Image Patch Similarity (LPIPS) as a similarity between two images.

The processor 180 can obtain the measured LPIPS as a similarity between the two images using the following [Equation 3].

$$LPIPS = \text{?} \frac{1}{\text{?}} \text{?} {‖ \text{?} ⊙ ( \text{?} - \text{?} ) ‖}_{2}^{2} \qquad [ Equation 3 ]$$

$$\text{?} \text{indicates text missing or illegible when filed}$$

Since the method of measuring LPIPS is an available technique, a detailed description thereof will be omitted.

In another embodiment, the processor 180 can use the image generation model 500 to compare a first attribute score obtained by quantifying a specific attribute of the expected image with a second attribute score obtained by quantifying a specific attribute of the cooking image being cooked.

The processor 180 can obtain a difference between the first attribute score and the second attribute score as a similarity between the two images.

The processor 180 can cook the food until the second attribute score becomes equal to the first attribute score.

As a result of the comparison, the processor 180 can output a cooking completion notification (S415) if it is determined that the expected image and the image of the food being cooked are similar (S413).

The processor 180 can determine that the two images are similar if the MSE is less than a preset value.

The processor 180 can determine that the two images are similar if the FID is less than a preset value.

The processor 180 can determine that the two images are similar if LPIPS is less than a preset value.

The processor 180 can determine that the two images are similar if the difference between the second attribute score and the first attribute score is less than a preset value or if the second attribute score and the first attribute score are equal to each other.

If it is determined that the two images are similar, the processor 180 can output a cooking completion notification.

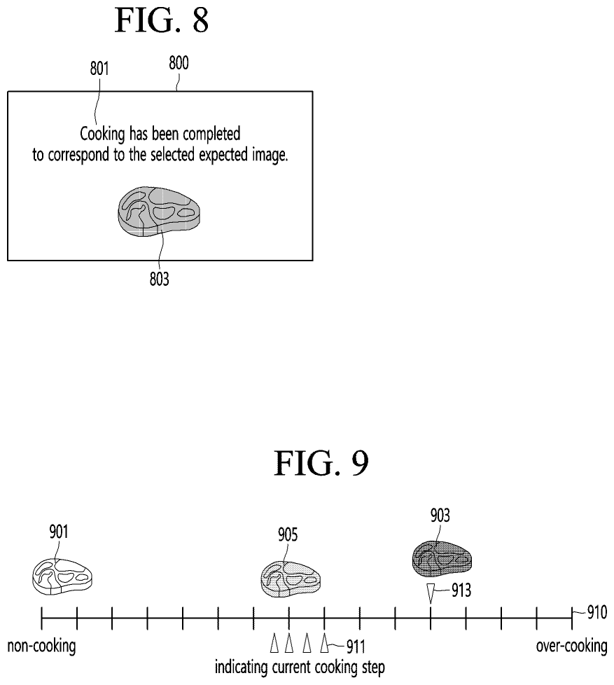

FIG. 8 is a diagram illustrating a cooking completion notification according to an embodiment of the present disclosure.

Referring to FIG. 8, the processor 180 can display a cooking completion notification 800 on the display unit 151 if it is determined that the expected image and the image being cooked are similar.

The cooking completion notification 800 can include a text 801 indicating completion of cooking and a cooking completion image 803 in a state in which cooking is completed.

The cooking completion notification 800 can include cooking information together with the cooking completion image 803.

The processor 180 can transmit a cooking completion notification 800 to the user's mobile terminal.

Meanwhile, the processor 180 can shorten the comparison period as the similarity between the two images approaches a preset value. That is, the processor 180 can initially lengthen the comparison period between the two images, and then shorten the comparison period as it approaches the preset value.

Again, FIG. 4 will be described.

As a result of the comparison, the processor 180 maintains cooking of the food if it is determined that the expected image and the image of the food being cooked are not similar (S413).

The processor 180 can output information about a current cooking stage while cooking food.

FIG. 9 is a diagram for explaining an example of displaying a cooking state for a current cooking step according to an embodiment of the present disclosure.

Referring to FIG. 9, the processor 180 can display an expected image 903 selected from the expected image set, a cooking image 905 in a current cooking step, and a cooking status bar 910 on the display unit 151.

A captured image 901 of the first food can also be displayed.

The cooking state bar 910 can be a bar that guides the progress of cooking. A first indicator 911 indicating a current cooking step and a second indicator 913 indicating a target cooking step can be displayed on the cooking state bar 910.

Even for the same food, the cooking time can vary depending on the amount of food.

In the present disclosure, the current cooking step and the target cooking step can be intuitively displayed through the cooking state bar 910 and the first and second indicators 911 and 913 regardless of whether the cooking state changes rapidly or the amount of food is large or small.

Meanwhile, if the expected cooking time corresponding to the expected image is changed, the processor 180 can provide the changed expected cooking time and the changed expected image.

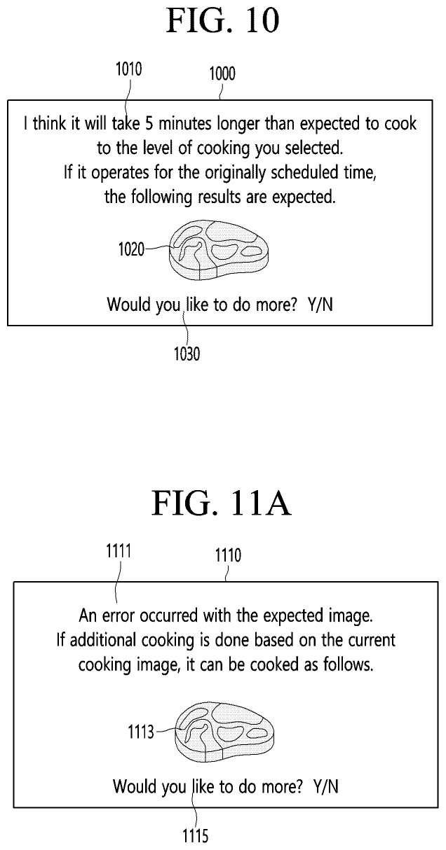

FIG. 10 is a diagram for explaining information provided if an expected cooking time corresponding to an expected image is changed according to an embodiment of the present disclosure.

The processor 180 can compare the expected image with the image being cooked and detect that the expected cooking time is changed based on the comparison result.

When detecting that the expected cooking time is changed, the processor 180 can display an expected cooking time change notification 1000 as shown in FIG. 10.

The cooking state change notification 1000 can include information 1010 on the changed expected cooking time, a modified cooking image 1020 if cooking is performed according to the initial expected cooking time, and an option 1030 on whether to additionally cook.

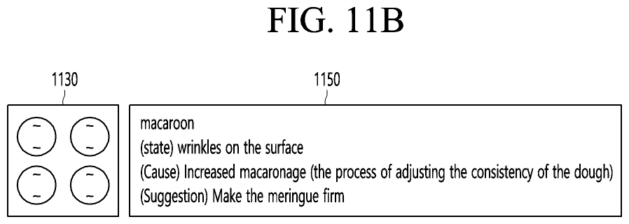

FIGS. 11A and 11B are diagrams illustrating output information if a cooking failure situation occurs according to an embodiment of the present disclosure.

After cooking for an expected cooking time corresponding to the expected image, the processor 180 can compare the expected image with an image of food in a fully cooked state.

After cooking for the expected cooking time, the processor 180 can determine that cooking has failed if it is determined that the expected image and the cooked image are not similar.

That is, the processor 180 can determine that an error between the expected image and the cooked image is greater than or equal to a threshold value.

If a cooking failure situation is detected, the processor 180 can display an error occurrence notification 1110 on the display unit 151 as shown in FIG. 11A.

The error occurrence notification 1110 can include a text 1111 indicating that an error has occurred between the expected image and the current cooking image (cooked image), a new expected image 1113, and an option 1115 inquiring whether to additionally cook.

The processor 180 can measure a similarity between the expected image and the current cooked image, and determine whether the measured similarity is less than a preset value.

If the measured similarity is determined to be less than a preset value, the processor 180 can obtain an additional cooking time until the measured similarity reaches the preset value.

The processor 180 can generate a new expected image 1113 based on the obtained additional cooking time and display the generated new expected image 1113.

If a cooking failure situation is detected, the processor 180 can display one or more of the current cooking image 1130 and cooking failure information 1150 on the display unit 151.

The cooking failure information 1150 can include one or more of a current cooking state of food, a cause of cooking failure, and a suggested cooking method.

The processor 180 can generate cooking failure information 1150 based on the current cooking image 1130. The processor 180 can transmit the current cooking image 1130 to an artificial intelligence server, and can receive cooking failure information 1150 indicating an analysis result of the current cooking image 1130 from the artificial intelligence server.

The artificial intelligence server can store pre-learned cooking failure scenario. The cooking failure scenario can include a cooking image and cooking failure information matched to the cooking image.

The user can be guided on a correct cooking method through the cause of cooking failure and the suggested cooking method included in the cooking failure information 1150.

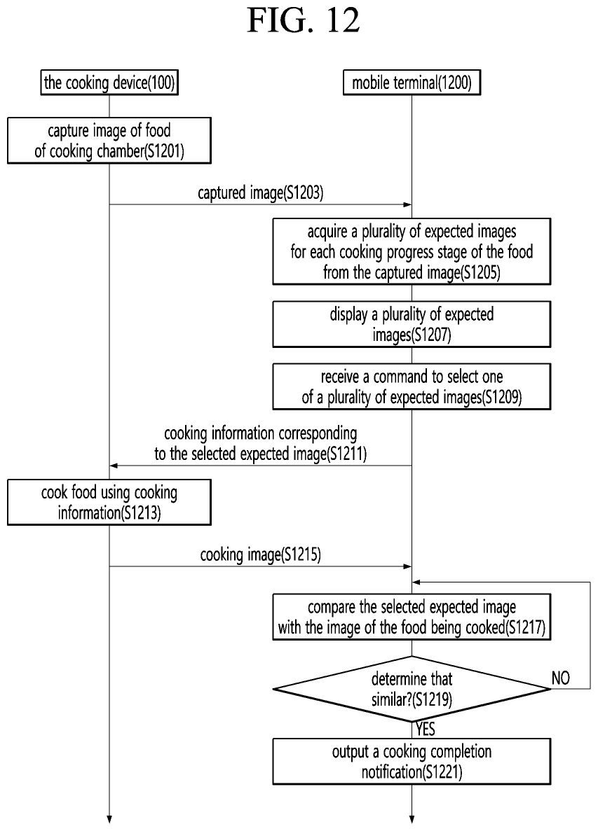

FIG. 12 is a ladder diagram for explaining an operating method of a cooking system according to an embodiment of the present disclosure.

The cooking system can include the cooking device 100 and the mobile terminal 1200.

The mobile terminal 1200 can be any one of a user's smartphone, smart pad, and PC.

The mobile terminal 1200 can include a display, a processor, and a wireless communication interface for wireless communication with the cooking device 100. The wireless communication interface can be either a Bluetooth circuit or a Wi-Fi circuit.

The processor 180 of the cooking device 100 can capture an image of food through the camera 121 (S1201).

The processor 180 of the cooking device 100 can transmit the captured image to the mobile terminal 1200 through the communication unit 110 (S1203).

The processor of the mobile terminal 1200 can generate a plurality of expected images for each cooking stage of food from the acquired image using an image generation unit (S1205).

The image generation unit can be the image generation unit 500 described in FIGS. 5A and 5B.

The image generation unit 500 can be included in the processor of the mobile terminal 1200.

The processor of the mobile terminal 1200 can display a plurality of expected images on the display (S1207).

What is displayed in the embodiments of FIGS. 6A to 6F can be displayed on the display of the mobile terminal 1200.

The processor 180 receives a command to select any one of a plurality of expected images (S1209), and transmits cooking information corresponding to the selected expected image to the cooking device 100 through a wireless communication interface according to the received command. It can (S1211).

The processor 180 of the cooking device 100 cooks food based on the received cooking information (S1213).

The processor 180 of the cooking device 100 can capture the food while it is being cooked and transmit the captured cooking image to the mobile terminal 1200 (S1215).

The processor of the mobile terminal 1200 can compare the selected anticipated image with the image of the food being cooked (S1217).

An embodiment corresponding to step S411 of FIG. 4 can be applied to the image comparison process.

If the processor of the mobile terminal 1200 determines that the expected image and the image of the food being cooked are similar as a result of the comparison (S1219), it can output a cooking completion notification (S1221).

The mobile terminal 1200 can display the cooking completion notification 800 of FIG. 8 on the display.

As a result of the comparison, the processor 180 maintains cooking of the food if it is determined that the expected image and the image of the food being cooked are not similar (S413).

According to an embodiment of the present disclosure, the above-described method can be implemented as computer readable code on a medium on which a program is recorded. A computer-readable medium includes all types of recording devices in which data that can be read by a computer system is stored. Examples of computer-readable media include Hard Disk Drive (HDD), Solid State Disk (SSD), Silicon Disk Drive (SDD), ROM, RAM, CD-ROM, magnetic tape, floppy disk, optical data storage device, etc.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A cooking device, comprising:
a display;
a cooking chamber;
a heating part configured to heat the cooking chamber;
a camera configured to capture an image of food located inside the cooking chamber; and
a processor configured to:
input the image into an image generation model that generates a changed image by manipulating a numerical value of an image attribute,
generate a plurality of expected images representing cooking progress stages of the food based on an output of the image generation model,
display the plurality of expected images on the display,
receive a selection for a selected expected image among the plurality of expected images, and
control the heating part to cook the food based on cooking information matched to the selected expected image.

2. The cooking device of claim 1, wherein the processor is further configured to:
in response to the image corresponding to a first type of food, generate a first expected image set including a plurality of first images, and
in response to the image corresponding to a second type of food different than the first type of food, generate a second expected image set including a plurality of second images.

3. The cooking device of claim 1, wherein the cooking information includes at least one of a cooking temperature, a cooking time period, and a degree of cooking the food.

4. The cooking device of claim 1, wherein the cooking process stages are classified based on one or more of a cooking time period, a degree of cooking of the food, and a degree of change in a shape of the food.

5. The cooking device of claim 1, wherein the processor is further configured to:
display a plurality of manipulation images guiding a manipulation button to be manipulated so that the food is cooked in a manner corresponding to each of the plurality of expected images.

6. The cooking device of claim 1, wherein the processor is further configured to:
display cooking information corresponding to each of the plurality of expected images.

7. The cooking device of claim 1, wherein the processor is further configured to:
display a cooking degree bar quantifying an amount of cooking corresponding to each of the plurality of expected images.

8. The cooking device of claim 1, wherein the processor is further configured to:
display a recommended expected image corresponding to a recommended cooking step based on a past cooking history of a user.

9. The cooking device of claim 1, wherein the processor is further configured to:
in response to a first type of food and a second type of food being in the cooking chamber, generate a first expected image set including a plurality of first images corresponding to the first type of food and a second expected image set including a plurality of second images corresponding to the second type of food, and
display the first expected image set and the second expected image set,
wherein the first type of food is different than the second type of food.

10. The cooking device of claim 1, wherein the processor is further configured to:
display sub-expected images based on subdividing a cooking step of the selected expected image.

11. The cooking device of claim 1, wherein the processor is configured to:
capture a subsequent cooking image of the food during cooking,
compare the subsequent cooking image with the selected expected image to generate a comparison result, and
in response to the comparison result indicating that a similarity between the subsequent cooking image and the selected expected image is equal to or greater than a predetermined amount, output a notification indicating that cooking is complete.

12. The cooking device of claim 11, wherein the comparison result is based on a first attribute score quantifying a specific attribute of the selected expected image and a second attribute score quantifying the specific attribute of the subsequent cooked image.

13. The cooking device of claim 1, wherein the processor is further configured to:
display the selected expected image, a cooking image corresponding to a current cooking step, and a cooking status bar indicating a cooking progress stage.

14. The cooking device of claim 1, wherein the processor is further configured to:
capture a subsequent cooking image of the food during cooking,
compare the subsequent cooking image with the selected expected image to generate a comparison result, and
in response to an expected cooking time corresponding to the selected expected image changing based on the comparison result, display a changed expected cooking time and a changed expected image.

15. The cooking device of claim 1, wherein the processor is further configured to:
in response to cooking being performed for an expected cooking time corresponding to the selected expected image, compare the selected expected image with a cooked image of the food corresponding to a cooking completion state, and
in response to the selected expected image being different than the cooked image, determine that the cooking has failed.

16. The cooking device of claim 15, wherein the processor is further configured to:
display a notification indicating that an error has occurred between the expected image and the cooked image or that the cooking has failed.

17. The cooking device of claim 15, wherein the processor is further configured to:
acquire an additional cooking time, and
display a new expected image based on the additional cooking time.

18. The cooking device of claim 15, wherein the processor is further configured to:
display cooking failure information including a cause of cooking failure of the food and a suggested cooking method.

19. The cooking device of claim 1, wherein the image generation model manipulates the image so that a plurality of attributes are reflected according to a conversion request of each of the plurality of attributes.

20. A method of controlling a cooking device, the method comprising:
capturing, via a camera in the cooking device, an image of food located inside a cooking chamber of the cooking device;
inputting, via a processor in the cooking device, the image into an image generation model that generates a changed image by manipulating a numerical value of an image attribute;
generating, via the processor, a plurality of expected images representing cooking progress stages of the food based on an output of the image generation model;
displaying, via a display of the cooking device, the plurality of expected images;
receiving a selection for a selected expected image among the plurality of expected images; and
cooking the food based on cooking information corresponding to the selected expected image.
